(19) United States
(12) Patent Application Publication
(10) Pub. No.: US 2017/0039617 A1
(43) Pub. Date: Feb. 9, 2017

(54) SHOPPING ASSISTANCE SYSTEMS, DEVICES AND METHODS TO SUPPORT CUSTOMERS

(71) Applicant: Wal-Mart Stores, Inc., Bentonville, AR (US)

(72) Inventor: Anthony G. Wind, III, Gravette, AR (US)

(21) Appl. No.: 15/229,666

(22) Filed: Aug. 5, 2016

Related U.S. Application Data
(60) Provisional application No. 62/202,671, filed on Aug. 7, 2015.

(51) Int. Cl. G06Q 30/06; G06Q 20/42; G06Q 20/40; G07G 1/00; G06Q 20/12

(52) U.S. Cl. CPC G06Q 30/0617; G07G 1/0072; G06Q 30/0635; G06Q 20/12; G06Q 20/405; G06Q 20/42

(57) ABSTRACT

In some embodiments, apparatuses and methods are provided herein useful to allow customer devices to authorize purchases. In some implementations, a system comprises: a purchase control system comprising: a control circuit; and a memory storing computer instructions that when executed by the control circuit cause the control circuit to: receive a request to register a remote consumer device; identify, from a plurality of different customers, a first registered customer with which the customer device is to be associated; associate the customer device with a customer account corresponding to the first customer; receive a purchasing authorization for the customer device as authorized by the first customer; and define purchasing authorization limits of the customer device that set limits on the customer device's authorization to initiate purchases over time on behalf of the first customer for one or more products corresponding to the operation of the customer device.

### CROSS-REFERENCE TO RELATED APPLICATIONS

This application claims the benefit of U.S. Provisional Application No. 62/202,671, filed Aug. 7, 2015, and is incorporated by reference in its entirety.

### TECHNICAL FIELD

These teachings relate generally to customer service and more particularly to devices, systems and methods for assisting customers in purchasing products.

### BACKGROUND

In a modern retail environment, there is a need to improve the customer service and/or convenience for the customer. Customers typically detect that they need to place a product when the product is used up. Shopping facilities typically stock products for purchase by customers. Customers generally enter the shopping facility having one or more items they intend to purchase. The customers travel through the shopping facility to locate the one or more products.

Upon locating the desired products the customer takes the one or more products to a checkout register or other point of sale. Each item is charged and the customer pays for the items. It is typically up to the customer to identify products to purchase, and to acquire and pay for the products desired.

### BRIEF DESCRIPTION OF THE DRAWINGS

Disclosed herein are embodiments of systems, apparatuses and methods pertaining to supporting customers in purchasing products. This description includes drawings, wherein:

FIG. 1 illustrates a simplified block diagram of an exemplary system 100 allowing customers to register customer devices and authorized those registered devices to initiate purchases of one or more products on behalf of a corresponding customer, in accordance with some embodiments;

FIG. 2 illustrates a simplified block diagram of an exemplary purchase control systems, in accordance with some embodiments;

FIG. 3 illustrates a simplified flow diagram of an exemplary process of registering customer devices in initiating and/or providing device authorized purchases, in accordance with some embodiments;

FIG. 4 illustrates a simplified flow diagram of an exemplary process of initiating and/or providing device authorized purchases, in accordance with some embodiments; and

FIG. 5 illustrates a simplified block diagram of an exemplary customer device, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, apparatuses and methods are provided herein useful to allow customer devices to be registered with one or more retailers and authorizing the device to make purchases on behalf of a customer. This can allow the customer device to identify when to make a purchase and initiating the purchase. By initiating the purchases, a customer is relieved of tracking the consumption of a product and remembering when and/or whether to purchase the product.

FIG. 1 illustrates a simplified block diagram of an exemplary system 100 allowing customers to register customer devices and authorized those registered devices to initiate purchases of one or more products on behalf of a corresponding customer, in accordance with some embodiments. In some embodiments, the system includes one or more purchase control systems 102, and customer devices 106 that are geographically distributed and correspond to numerous different customers. The purchase control systems 102 may be stand-alone systems or in some instances may be part of and/or correspond to one or more retail entities 104 (e.g., shopping facilities, chains of shopping facilities, on-line retailers, other such retail entities), distribution centers, wholesalers, service providers (e.g., automotive service providers, maintenance service providers, and/or other such entities), and the like. For simplicity, the below description generally refers to retail entities that sell products; however, those skilled in the art will appreciate that some or all of the below embodiments, features and capabilities can equally apply to service providers, distribution centers, and other relevant entities. The customer devices 106 are in communication with one or more of the purchase control systems 102 through one or more a wired and/or wireless distributed communication networks 108 (e.g., WAN, LAN, Internet, cellular, other such networks, and combinations of such networks), and/or in communication with one or more hubs or relay systems 110 that in turn enable communication with one or more purchase control systems via the distributed network. Further, customers typically can remotely communicate with one or more purchase control systems 102 and/or retail entities 104 through one or more user interface units (UIU) 114, which can allow the customer to register customer devices, provide authorizations, define parameters, obtain information, receive notifications and other such communications. For example, the user interface units may include but are not limited to smart phones, cell phones, laptops, tablets, computers, or other such portable consumer electronic user devices. In some embodiments, one or more registration services 116 may be provided that allow customers to register one or more customer devices 106, and provide registration information and/or confirmation to purchase control systems 102.

The purchase control systems 102 and/or retail entities are configured to allow customers to register one or more customer devices 106 and define one or more authorizations. Based on the registration and authorization, the customer devices can communicate with the purchase control systems and initiate a purchase of one or more products. In some implementations, the customer device is configured and/or authorized to autonomously submit a request to initiate a purchase of a product without user interaction at the time of submitting the request and/or such that the consumer does not have to activate the customer device to submit the request. Accordingly, the customer device can be configured to initiate the purchase of one or more products on behalf of the customer without customer interaction to initiate the purchase. The purchase control systems 102 can be configured to include one or more point of sale (POS) systems 118 and/or are in communication with one or more POS systems that are configured to charge a customer for a purchase and/or otherwise obtain and/or register payment. Still further, the purchase control systems 102 are typically in communication with and/or include one or more databases 120 that store customer information, customer device information, registration information, product information, pricing information, and other such information.

In some implementations, the customer devices 106 are configured to track and/or detect when one or more products are to be replaced and/or replenished. In response, the customer device initiates a purchase of the one or more products from one or more purchase control systems 102 and/or retail entities. In some embodiments, some purchase control systems 102 are configured to register hundreds of thousands of customer devices 106 or more, and allow those customer devices to at least initiate purchases on behalf of one or more corresponding customers. Typically, each customer (or a group of customers, such as family members) is registered and/or has established an account with the purchase control systems, retail entity (sometimes referred to as retailer), registration service, or the like. The registered customer can then register one or more customer devices that are to be associated with that customer, and can authorized the customer device to initiate and/or complete purchases of one or more products.

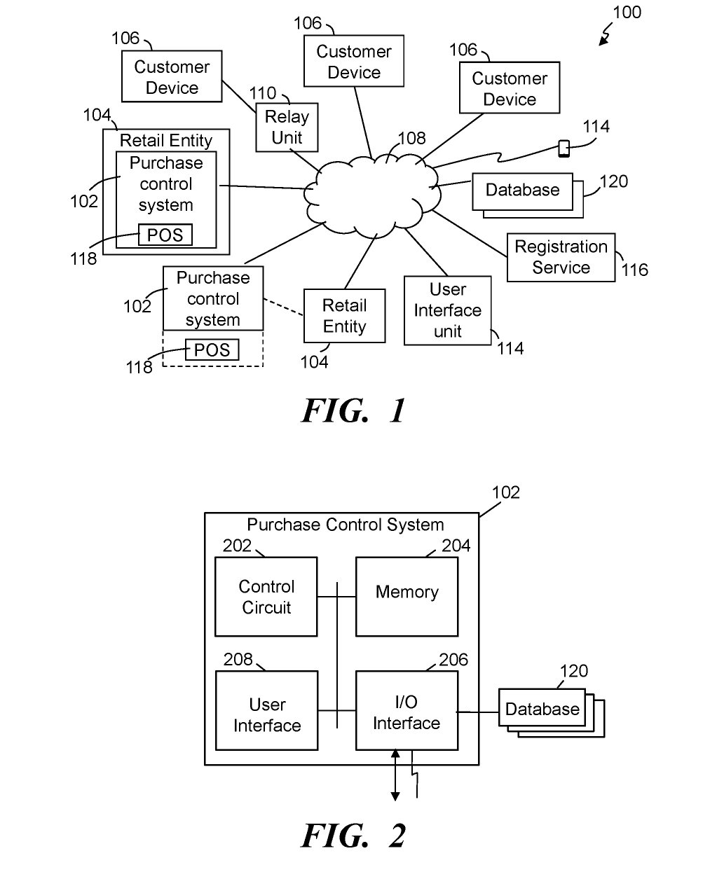

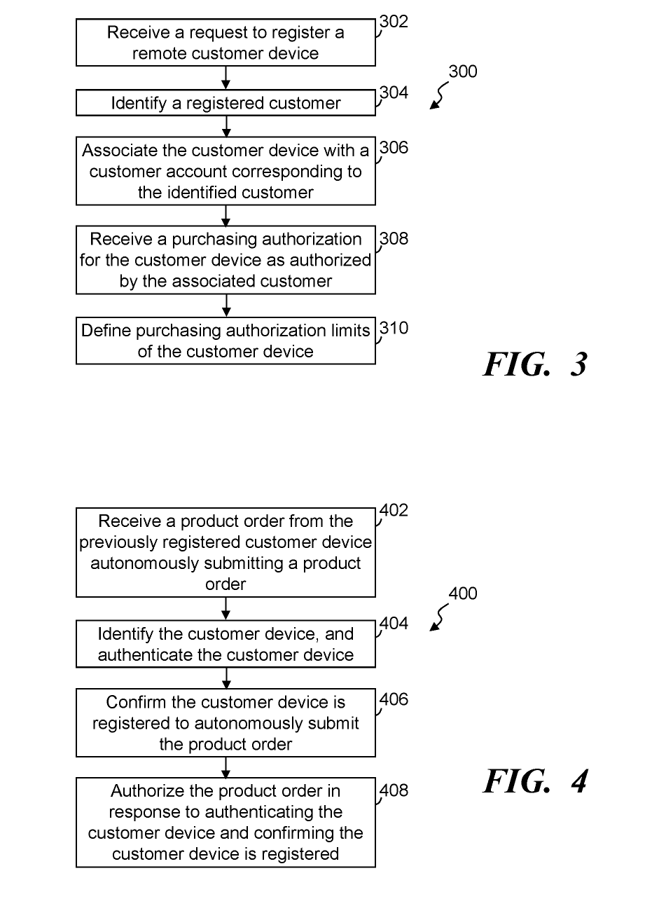

FIG. 2 illustrates a simplified block diagram of an exemplary purchase control systems 102, in accordance with some embodiments. As described above, the purchase control system is configured to register one or more remote customer devices and allow those customer devices to initiate purchases on behalf of a customer. In this example, the purchase control system 102 includes a control circuit 202, memory 204, and input/output (I/O) interfaces 206. Further, the purchase control system typically includes one or more user interfaces 208 configured to allow associates, workers, users and the like to interact with the purchase control system (e.g., in maintaining the system, updating the system, supporting customers, and the like). In some embodiments, the purchase control system and/or the control circuit 202 can be implemented through one or more servers. The one or more servers may be implemented independent of a retail entity, or as part of a retail entity system. In some embodiments, the purchase control system is implemented through a plurality of computers and/or servers that are distributed over one or more communication networks (e.g., the communication network 108), and may be geographically distributed while still being communication coupled to cooperatively operate to perform the functions of the purchase control system. Additionally, the purchase control system 102 may be utilized with a single retail entity and/or shopping facility (e.g., a store location, shopping mall, retail campus, or the like), while in other implementations, the purchase control system may extend across multiple retail entities and/or shopping facility locations (e.g., associated with a chain of retail facilities).

The control circuit 202 typically comprises one or more processors and/or microprocessors. The control circuit couples with and/or includes the memory 204. Generally, the memory 204 stores the operational code or set of instructions that are executed by the control circuit 202 and/or processor to implement the functionality of the purchase control system. In some embodiments, the memory 204 may also store some or all of particular data that may be needed to allow device registration, customer registration, profile management, authentication, purchasing, and the like. Such data may be pre-stored in the memory or be received, for example, from a retail entity, third party registration service 116, inventory systems, point of sale systems, shopping facility systems, customer devices, customer user interface units, other sources, or combinations of two or more of such sources. It is understood that the control circuit may be implemented as one or more processor devices as are well known in the art. Further, the control circuit may be implemented through multiple processors dispersed over the distributed network.

Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the purchase control system; however, the memory 204 can be internal, external or a combination of internal and external memory. Additionally, the purchase control system may include a power supply (not shown) and/or it may receive power from an external source. In some instances, the control circuit 202 and the memory 204 may be integrated together, such as in a microcontroller, application specification integrated circuit, field programmable gate array or other such device, or may be separate devices coupled together. In some applications, the control circuit 202 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 206 allow wired and/or wireless communication coupling of the purchase control system to external components, such as the customer devices 106, databases 120, the user interface units 114, retail entity systems, distribution center systems, point of sale systems 118, and other such components. Accordingly, the I/O interface 206 may include any known wired and/or wireless interfacing device, circuit and/or connecting device, such as but not limited to transceivers, receivers, transmitters, and the like. For example, in some implementations, the I/O interface 206 provides wireless communication in accordance with one or more wireless protocols (e.g., Wi-Fi, Bluetooth, radio frequency (RF), cellular, other such wireless communication, or combinations of such communication). In some implementations, the I/O interface includes one or more transceivers configured to couple with and receive communications from over the distributed communication network 108.

One or more user interfaces 208 can be included in and/or coupled with the purchase control system 102, and can include substantially any known input device, such one or more buttons, knobs, selectors, switches, keys, touch input surfaces and/or displays, etc. Additionally, the user interface may include one or more output display devices, such as lights, visual indicators, display screens, etc. to convey information to a user, such as status information, history information, product storage identifiers, product information, product identifiers, customer profile information, product consumption information, graphical user interface, purchase information, notifications, errors, conditions and/or other such information. While FIG. 2 illustrates the various components being coupled together via a bus, it is understood that the various components may actually be coupled to the control circuit 202 and/or one or more other components directly.

FIG. 3 illustrates a simplified flow diagram of an exemplary process 300 of registering customer devices in initiating and/or providing device authorized purchases, in accordance with some embodiments. In some implementations, at least part of the process 300 is implemented through the purchase control system 102. Additionally or alternatively, some of the steps may be performed by one or more registration services 116 (which may be associated with a retail entity, or a third party entity that is utilized by the purchase control system, retail entity, etc.), a customer device manufacturer, other such entities, or combination of two or more of such systems and entities.

In step 302, a request is received to register a remote customer device 106. The request is typically initiated by the customer. In other instances, however, the registration may be initiated through other actions such as, but not limited to, in response to a customer making a purchase of the customer device (e.g., through a POS system, through a server accessed by the customer while purchasing the customer device, or other such source), the customer device initiating registration (e.g., in response to an initial power up), and other such actions. The registration typically includes the customer identifying her/himself, such as logging in to a customer account (e.g., a customer account maintained by a retail entity), establishing a customer account, providing customer information, or the like. The registration typically also includes providing an identification of the customer device 106 that is being registered.

In some embodiments, the registration may be implemented in part or in full through the customer device. For example, the customer device may include a user interface (e.g., buttons, knobs, selectors, switches, keys, touch input surfaces and/or displays, lights, visual indicators, display screens, etc.), that can be used to initiate the registration of the device. For example, a button, series of buttons and/or one or more options displayed options may be selected to initiate a connection with the purchase control system. The communication between the purchase control system and the customer device can include obtaining information about the device (e.g., unique device identifier, device functionality, device capabilities, etc.), identification of a customer, one or more products of which the customer device is authorized to initiate purchases, parameters and/or limits on the customer device and/or its authorization to initiate and/or complete a purchase, and the like.

Additionally or alternatively, a customer may initiate and/or implement some or all of the registration of a customer device through a user interface unit 114. For example, the customer may initiate the registration through a software application (APP) on a smartphone, access an Internet site through a smartphone, computer, etc., or other such access to a registration service. In some instances, the registration may be partially performed through a user interface unit (e.g., logging into a customer account, providing relevant customer information, specifying one or more products for which the customer device is authorized to initiate purchases, parameters and/or limits on the customer device and/or its authorization to initiate and/or complete, and the like), while another portion of the registration is performed through the customer device being registered. For example, the registration may be implemented through a web site of a shopping facility and/or retail entity, a third party registration service that one or more retail entities can access to confirm registration upon receiving a subsequent request from a customer device to purchase a product, and the like. In other instances, the initiation of the purchase by the device may go through the third party service, with the third party service identifying and authenticating the customer device on behalf of a retail entity. The third party service may then hand over communication to the retail entity once the device is authenticated, or the purchase may be relayed through the third party service providing communication between the retail entity and the customer device.

In step 304, a registered customer is identified, from a plurality of different customers, with which the device is associated or is to be associated. For example, the customer may have logged into a customer account/profile, a customer may provide relevant information to initiate a customer registration, an identification of a user interface unit may be detected and associated with a customer, information provided (e.g., GPS location, address, phone number, etc.) may be detected and a customer recognized, or other such methods. In some instances, more than one registered customer may be identified (e.g., multiple registered customers living at a single residence, associated with a single customer account, having linked customer accounts (e.g., spouses, child/children, parent, etc.)). Again, the purchase control system 102 is configured to allow the initiation of product purchases from hundreds of thousands if not tens to hundreds of millions of different product devices, and a customer is associated with each of the devices registered so that the purchase can be accurately charged and provided to the relevant customer.

In step 306, the customer device is associated with one or more customer accounts corresponding to the identified customer. Typically, the association between the customer device and the one or more customers is performed as part of the registration of the customer device. This can further include having the relevant one or more customers confirm the association between customer and device, and in some instances, specify one or more authorizations. In some embodiments, the association is based on a location of the customer device (e.g., the customer device may include a global positioning system that can provide location information, a location may be determined based on network connectivity, etc.). Other methods of associating the device with one or more customers can be implemented, such as customer request, customer providing information, purchase being associated with a customer making the purchase, etc. Further, some embodiments, initiate a communication with the customer (e.g., through a text message, phone call, email, etc.) requesting that the customer confirm the association. The communication may be through a separate method of communication through which the customer device communicates. Often multiple devices are associated with a single customer and/or customer account.

In step 308, a purchasing authorization is received for the customer device as authorized by one or more of the associated customers. This purchasing authorization can include an identification of one or more products the customer device is authorized to purchase. In some embodiments, the customer identifies the relevant product or products. Additionally or alternatively, the customer during the registration process may be provided a listing of one or more products, a set of icons of one or more products may be displayed, information about products may be provided to allow the customer to evaluate products and/or shop for one or more products to be authorized, and the like. The customer may select from the listing and/or icons, or override and enter a specific product. Still further, the customer may access products offered for sale by a corresponding retail entity, browse through the products and select the one or more products being authorized. The purchasing authorization may further include identifying a specific product with size, quantity, etc.; while in other instances, the authorization may specify a brand of product (e.g., a brand of dishwashing detergent, a brand of batteries, brand of toothpaste, etc.), a general type of product (e.g., cloths washing soap, toothpaste, etc.), or other such more general identification, and authorize the purchase control system 102, a POS 118, a retail entity system, or other such system to later select a particular product (e.g., brand, size, etc.) to be purchased (e.g., based on best value, based on customer defined limits, purchase history, or other such factors, or a combination of two or more of such factors). In some embodiments, the purchasing authorization authorizes the customer device to autonomously initiate and/or complete a purchase on behalf of the customer. Further, the purchasing authorization can be maintained by the purchase control system. For example, a customer device profile may be maintained for one or more registered customer devices, and/or the authentication may be maintained in a customer profile (e.g., with an identification of the one or more customer devices registered and their authorization, lack of authorization, level of authorization, etc.).

In step 310, purchasing authorization limits of the customer device may optionally be defined that set limits on the customer device's authorization to initiate purchases over time on behalf of the customer for one or more products, which typically correspond to the operation of the customer device. The limits can be substantially any relevant limit. For example, limits may be based on total amount of money that can be authorized by the customer device during a predefine period of time (e.g., the customer device may be authorized to initiate the purchase of cloths washing soap of up to $20.00 every four months); limit quantities, weights, sizes, etc. that are authorized; a number of times a device can initiate a purchase; a number of times a device can initiate a purchase without getting further authorization; restricting the authorization of a product, brand of product, type of product, etc.; whether additional customer authorization is needed prior to completing the purchase; and other such limits. As a further example, the one or more limits may include receiving one or more product identifiers that the customer device is authorized to purchase, and/or receiving one or more quantity limits corresponding to each of the received one or more product identifiers. Each of the quantity limits may define a maximum number of the corresponding product the customer device is authorized to purchase, and further may specify a time period, a maximum amount of time, or other relevant timing limit. The limits, in part, can provide protection to the customer, such as in the event a customer device is maliciously hacked and the hacker attempts to make excessive purchases.

It is noted that some portions of the process 300 may be implemented over time. For example, the registration of the customer device may occur when a customer activates the device. The purchase authorization, however, may not occur until a later time, such as after a customer has a chance to review potential products, after the customer evaluates the operation of the customer device for a period of time, and other such actions. Similarly, one or more parts of the process 300 may be implemented independent of other parts. For example, the customer may update and/or modify purchase authorization without having to re-register the device or associate the customer with the device.

FIG. 4 illustrates a simplified flow diagram of an exemplary process 400 of initiating and/or providing device authorized purchases, in accordance with some embodiments. In step 402, a product order is received at the control circuit 202 of the purchase control device from a previously registered customer device 106 autonomously submitting a product order such that the consumer does not have to initiate the submission or activate the customer device to submit the product order. Again, the customer devices is typically previously authorized to initiate a purchase of one or more products, and the product order specifies one or more products to be purchased on a behalf of the customer with whom the customer device is associated. As described above, in some implementations, the purchase control system 102 corresponds to a specific retailer and in receiving the product order is further configured to receive directly at the specific retailer the product order from the customer device that has previously been registered with the specific retailer and with which the customer is also previously registered.

In step 404, the customer device 106 submitting the product order is identified and typically a corresponding customer is identified. In some instances, the customer device is further authenticated. Typically, the customer device submitting the product order includes a unique identifier and/or a registration number that is unique, at least to the purchase control system, to the customer device. The purchase control system can use this information to accurately identify the customer device. In some instances, the identifier further provides at least some authentication. The authentication may include obtaining a password or phrase from the customer device (e.g., established at registration), receiving the product order encrypted according to an encryption key unique to the customer device (e.g., provided to the customer device during registration), and/or other such authentications in attempt to limit and/or prevent unauthorized purchases and/or malicious activity. Still further, communications between the customer device and the purchase control system can include protections, such as encryption, passwords, predefined formats, token based communications, scrambling, and/or other such protections.

In some embodiments, some or all of the communications may be encrypted. In some instances, communications may be communicated on the fly (for example, HTTPS or other secure communication channel). Additionally or alternatively, the device may employ a dual key encryption process (e.g., publically encrypted, and privately decrypted using one or more keys). In some implementations, the device identifier and/or other such information may not be protected, such as when a customer authorization is required before an order is authorized (e.g., rule set that customer has to authorize a request from a particular device and/or any purchases). Some embodiments may further apply one or more token based protection schemes, such as through one or more security management systems. For example, the device may obtain a token from a security management system, and upon receiving the token the retailer can validate the token.

In step 406, the purchase control system confirms the customer device is registered to autonomously submit the product order on behalf of the first customer. Again, the customer typically registers the customer device and authorizes the device to autonomously initiate and/or complete a purchase of one or more products on behalf of the customer. This authorization is typically maintained in a customer device profile and/or a customer profile for the customer with which the customer device is associated.

In step 408, the purchase control system receives and authorizes the product order. The customer device communicates the requested purchase, and/or the purchase control system identifies the product or products to be purchased through a customer device profile and/or a customer profile. In some instances, the purchase control system may at least in part identify or select the specific product to products to purchase (e.g., based on sales, sizes and/or quantities available, etc.), applying one or more parameters defined during the authorization process, customer profile, customer shopping history, and the like. Typically, this authorization of the product order is in response to at least authenticating the customer device and confirming the customer device is registered. The authorization of the product order can include a notification to a retail entity and/or an inventory system of a retail entity from which to obtain the one or more products, reduce an inventory count of the one or more products and/or otherwise reserve the one or more products on behalf of the customer. The one or more products may further be collected and prepared for pick-up by the customer and/or delivered to the customer (e.g., to a delivery address specified in a customer profile, a customer device profile, communicated by the customer device, etc.).

In some embodiments, the authorization of the product order can, at least in part, communicate to a point of sale system to implement the purchase. Accordingly, some embodiments further identify the customer corresponding to the registered customer device, such as based on a customer account established upon registration of the customer, identify a method of payment specified within the customer account, and initiate a charge to the method of payment for a cost of the one or more ordered products. This can include charging a credit card, debiting a gift card, applying any coupons, applying any credits, and/or other such payment methods. Alternatively, an account may be charged and billed to the customer such that the customer subsequently pays the bill.

The authorization for the purchase, in some instances, may not initiate a purchase. For example, in some embodiments, the purchase control system may delay the actual purchase until a threshold number of products are authorized, a threshold amount of money for purchases has been authorized, and the like. The customer device may specify a time when the product is to be delivered by (e.g., based on predicted depletion of the product), and the purchase may occur within the specified time. Similarly, a retail entity may recognize that the corresponding customer has a scheduled delivery and/or purchase in the future and determine (e.g., based on thresholds, customer specified parameters, etc.) that the actual purchase be delayed until the subsequent order is to be fulfilled, and/or add the product to a purchase order that is to be subsequently fulfilled. In some instances, the actually purchase may occur through a separate entity, and as such the purchase control system may forward the purchase authorization, and the separate entity may determine when to implement the purchase.

Again, the customer can specify one or more limits and/or factors that can restrict the customer device's ability to initiate purchases, what can be purchased, quantities of what can be purchased and other such limits. As such, in some implementations, the control circuit 202 of the purchase control system is further configured to evaluate the product order, and confirm that the one or more products being ordered comply with the one or more purchasing authorization limits specified and associated with the registered customer device prior to the device authorizing the product order. The control circuit of the purchase control system can then authorize the product order in response to authenticating the customer device, confirming the customer device is registered, and confirming the one or more products being ordered comply with the one or more purchasing authorization limits.

In some embodiments, the purchase control system may confirm that a purchase order is consistent with predicted usage. As such, the control circuit can evaluate each of the one or more products of the product order and for each of the one or more products determining whether a requested quantity of the product complies with a predicted usage of the product since a subsequent product order purchasing the product. This can provide further confirmation that the requested purchase complies with customer demand, and potentially avoid malicious attacks.

The purchase control system, in some implementations, notifies the customer of the purchase and/or does not authorize the purchase until a confirmation and/or authorization is received from the customer. Whether a notification is communicated, whether the confirmation is needed and/or when a confirmation is to be obtained can be defined as part of the device registration, subsequently specified, and/or as part of the limits. In some instances, for example, the customer confirmation may be needed prior to every purchase. In other instances, the confirmation may be requested in response to a particular product being ordered (e.g., as defined in the limits, laws, etc.), in response to a cost for the purchase exceeding a threshold, a product order being submitted within a threshold time of a previous product order, and/or other such factors. In some applications, the control circuit 202 is further configured to communicate an authorization request to a user interface unit corresponding to the customer, requesting that the customer confirm authorization for the purchase of the one or more products. The control circuit then authorizes the product order in response to authenticating the customer device, confirming the customer device is registered, and receiving an authorization from the customer in response to the authorization request. The notification and/or authorization request may be a text message, email, phone call, a notification through an APP on the customer's user interface unit, and/or other such communications. The authorization from the customer can similarly be a reply text, email, a voice confirmation, a selection of an option of an APP, or other such response.

The customer may be notified of the purchase. For example, in response to the purchase a text message, email or the like may be communicated to the customer. The notification may be delayed and communicated according to a schedule (e.g., once a week, once a month, etc.), when a threshold number of products are purchased, when a threshold amount of money has been spent, etc.

In some embodiments, the control circuit in receiving the product order is further configured to receive the product order in response to the customer device making a determination that the one or more products should be purchased on behalf of the customer. The determination can be based on one or more factors and/or the capabilities of the customer device. As some examples, the customer device may track: a number of occurrences of an event (e.g., a dishwasher and/or clothes washer can track a number of cycles performed, a pay-as-you-go phone may track a number of minutes consumed, a battery operated device may track a duration the device is in an on state, a car may track a number of miles traveled, etc.), which may correspond to the depletion of a known quantity of a product; sensor data (e.g., a battery operated device may include a battery charge detector; a dispensing device may detect levels and/or quantities of a dispensed product; a weight detector may detect the weight of a product, a water filter system may include a flow sensor and track the quantity of water filtered, etc.); track time (e.g., a device may track how long it is in an on state; a device may track how long it has been since an action or replacement of a product was done); and other such tracking to be used in determining whether to autonomously submit a product order. As a further example, a customer device may identify that a quantity of at least one of one or more products is equal to or less than a product threshold (e.g., a number of washing cycles have occurred corresponding to a depletion of a corresponding number of washing tablets or available detergent). In some embodiments, the registered customer device can include a product storage unit that can store and track the consumption of one or more products. As yet another example, the customer device can be a product storage unit as described in co-pending U.S. Provisional Patent Application No. 62/152,699, filed Apr. 24, 2015, and entitled AUTOMATED SHOPPING APPARATUS AND METHOD IN RESPONSE TO CONSUMPTION, which is incorporated herein by reference.

The customer device 106 includes one or more transceivers and/or other components that allow the customer device to communicate with one or more external devices. The communication may be via wired and/or wireless communication. Further, the communication capabilities may allow the customer device to directly communicate with a purchase control system. In other instances, the customer device may not be in direct communication with the distributed network 108, and instead may communicate through a relay system 110. Additionally or alternatively, the customer device may be incorporated within a local area network and in communication via the location area network with one or more relay systems 110, and the relay system provides a communication portal to a wide area network (e.g., a WAN, the Internet, etc.). In some embodiments, the relay system 110 is configured to establish one or more communication connections over the distributed network 108 with one or more remote entities, such as but not limited a purchase control system 102, to one or more retail entities 104, service providers, and/or other such entities. In some embodiments, the relay system 110 can be a user interface unit, such as a computer, laptop, smartphone, or other such device. In other instances, the relay system may be another customer device, a thermostat of a residence or business, a television, or other device that is configured to receive communications from other devices of a local area network and relay communications over the distributed network 108 to intended destinations. For example, in some implementations, the customer devices are configured to communicate via Bluetooth, Wi-Fi or other local wireless network with a user interface unit 114 that can utilize some or all of the information, act as a relay between the device and the purchase control system 102, and the like.

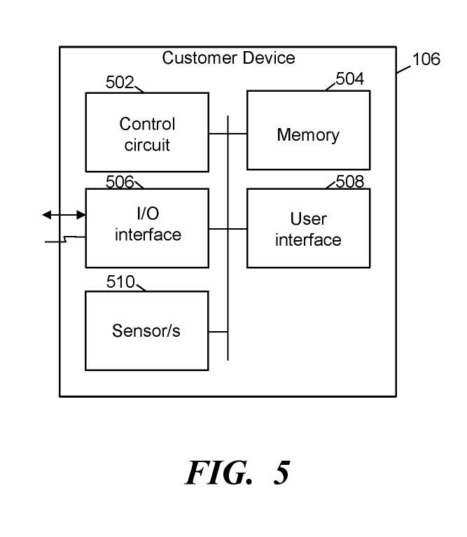

FIG. 5 illustrates a simplified block diagram of an exemplary customer device 106, in accordance with some embodiments. The customer device can include one or more control circuits 502, memory 504, and input/output (I/O) interfaces 506. Some embodiments further include a user interface 508. Still further, in some implementations the customer device may also include one or more sensors, detectors, and the like.

The control circuit 502 typically comprises one or more processors and/or microprocessors. The memory 504 stores the operational code or set of instructions that is executed by the control circuit 502 and/or processor to implement the functionality of the customer device 106. In some embodiments, the memory 504 may also store some or all of particular data that may be used to implement the functionality to autonomously initiate an product purchase (e.g., in some instances, submit a product order), and in some instances further implement the functionality of the customer device (e.g., control wash cycles, control drying, etc.). Additionally, the functionality may allow the customer device to track one or more parameters and/or factors in determining when to initiate the product purchase, store product identification information, store product size and/or quantity information, track product consumption, maintain thresholds, communicate information, and the like. Some such data may be pre-stored in the memory, received from an external source (e.g., the purchase control system 102), be determined, and/or communicated to the customer device, such as from a user interface unit 114, retail facility, distribution center, other source or combination of such sources. It is understood that the control circuit 502 and/or processor may be implemented as one or more processor devices as are well known in the art.

Similarly, the memory 504 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 504 is shown as internal to the customer device 106; however, the memory 504 can be internal, external or a combination of internal and external memory. Additionally, the customer device typically includes a power supply (not shown) and/or it may receive power from an external source. While FIG. 5 illustrates the various components being coupled together via a bus, it is understood that the various components may actually be coupled to the control circuit 502 and/or one or more other components directly.

Generally, the control circuit 502 and/or electronic components of the customer device 106 can comprise fixed-purpose hard-wired platforms or can comprise a partially or wholly programmable platform. These architectural options are well known and understood in the art and require no further description here. The customer device and/or control circuit can be configured (for example, by using corresponding programming as will be well understood by those skilled in the art) to carry out one or more of the steps, actions, and/or functions described herein. The control circuit 502 and the memory 504 may be integrated together, such as in a microcontroller, application specification integrated circuit, field programmable gate array or other such device, or may be separate devices coupled together.

The I/O interface 506 allows wired and/or wireless communication coupling of the customer device to external components, such as the purchase control system 102, user interface units 114, a relay system 110, wired and/or wireless routers, and other such components or systems. For example, the I/O interface 506 provides wireless communication (e.g., Wi-Fi, Bluetooth, cellular, RF, and/or other such wireless communication), and in some applications may include any known wired and/or wireless interfacing device, circuit and/or connecting device, such as but not limited to transceivers, received, transmitters, and the like.

The one or more user interfaces 508 are used for user input and/or output. For example, the user interface 508 may include any known input devices, such one or more buttons, knobs, selectors, switches, keys, touch input surfaces, audio input unit, and/or displays, etc. Additionally, the user interface may include one or more output display devices, such as lights, visual indicators, display screens, touch screens, etc. to convey information to a user, such as but not limited to, customer device information (e.g., device identifier, device capabilities, thresholds, etc.), product information (e.g., information regarding one or more products purchased, history of purchases, current count or level of a current product, amount of a product consumed, date product is anticipated to be fully consumed, thresholds, etc.), customer information (e.g., identification, contact information, address, preferences, etc.), shopping or product list information, other communication information (e.g., text messages, emails, etc.), status information, operating status information, notifications, alerts, errors, conditions, and/or other such information. Similarly, the user interface in some embodiments may include audio units and/or systems that can receive audio commands or requests verbally issued by a user, and/or output audio information.

The customer device 106 may further include one or more sensors 510, detectors or the like. For example, the customer device may include a battery charge level detector, product level detector, a counter, a weight detector, timer, product identifier detector (e.g., bar code reader, RFID tag detector, etc.), other such sensors, or combination of two or more of such sensors. For example, the one or more sensors may be configured to track the consumption of one or more products through an evaluation of each products use, operating time of the device, number of times the device is activated, etc. Similarly, time information may be tracked in determining whether a product has expired, is expected to be consumed, or the like. The consumption information can then be communicated to the control circuit 502.

Further, in some embodiments, one or more of the product tracking information can be detected by the control circuit (e.g., tracking time, tracking counts, etc.) and/or such product tracking information is provided to the control circuit. The control circuit can evaluate the product tracking information in determining whether a purchase should be initiated. For example, the control circuit can evaluate the product tracking information relative to one or more thresholds and initiate the product purchase when a predefined relationship is detected relative to the one or more thresholds. Similarly, the product tracking information can be used to predict or determine a rate of consumption, predict when a product is expected to be completely consumed, whether a product is expected to passed an expiration date, and other such information. Based on the predicted consumption, the customer device may initiate a purchase prior to actually depleting the product so that there is sufficient time to receive the replacement product before completely depleting the local product. This prediction may be specified, for example, as a default, set by a user (e.g., through the user interface), set as a limit and/or as part of the registration of the customer device, and the like.

The authorization of customer devices to autonomously initiate purchases on the customer's behalf can simplify shopping for the customer, ensure customers do not run out of a desired product, enhance customer loyalty, improve customer relations, improve customer sales, and other such benefits. Customers do not have to track products to identify when to purchase products, do not have to remember to purchase the product when they are at the store or performing other relevant shopping, avoid running out of products, and the like. More customer devices are provided with communication capabilities. Accordingly, the purchase control systems can allow communications to be established with these devices and allow these devices to at least initiate purchased on behalf of the customer and in accordance with predefined limits. Current ecommerce customer orders are typically submitted via a human driven user interface. With the communication capabilities being incorporated into customer devices a multitude of autonomous devices can be configured to monitor product consumption and be capable of performing tasks such as product ordering on behalf of the owner of these devices. Through the registration and authorization of these devices, customers can allow these devices to autonomously implement relevant purchases. Further, limits and conditions can be set to provide protection to customers. As such, retail and/or service entities can accept customer orders from designated proxy devices.

In some embodiments, the customer device additionally or alternatively may autonomously authorize and/or purchase services. For example, a registered septic system may track and/or sense when service is needed and communicate with a service provider and/or third party to authorize the service. Similarly, a registered cloths washing machine may track time and communicate an authorization for a routine maintenance, or detect a problem (e.g., through a sensor) and authorize service. A registered car may communicate with an automotive service and schedule an appointment for maintenance and/or repair. As described above, the purchases may be based on sensor data. For example, a customer may have a registered bracelet, watch or other device that can track characteristics about a customer (e.g., blood pressure, pulse, etc.), and initiate purchased based on conditions (e.g., authorize a purchase of prescription medicine for blood pressure). As described above, some purchases may require customer authorization, which may be specified by limits. In some instances, for example, customer authorization is requested when a purchase request does not comply with limits. For example, with medicine, it can be determined whether there has been a threshold amount of time based on amount of medication previously supplied and dosage amount customer is prescribed to take.

In some embodiments, apparatuses and methods are provided herein useful to allow customer devices to authorize purchases. In some embodiments, a system comprises: a purchase control system comprising: a control circuit; and a memory coupled to the control circuit and storing computer instructions that when executed by the control circuit cause the control circuit to: receive a request to register a remote consumer device; identify, from a plurality of different customers, a first registered customer with which the customer device is to be associated; associate the customer device with a customer account corresponding to the first customer; receive a purchasing authorization for the customer device as authorized by the first customer; and define purchasing authorization limits of the customer device that set limits on the customer device's authorization to initiate purchases over time on behalf of the first customer for one or more products corresponding to the operation of the customer device.

In some embodiments, a method of providing customer device authorized purchases, comprises: by a control circuit of a purchase control system: receiving a request to register a remote consumer device; identifying, from a plurality of different customers, a first registered customer with which the customer device is to be associated; associating the customer device with a customer account corresponding to the first customer; receiving a purchasing authorization for the customer device as authorized by the first customer; and defining purchasing authorization limits of the customer device that set limits on the customer device's authorization to initiate purchases over time on behalf of the first customer for one or more products corresponding to the operation of the customer device.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system providing customer device authorized purchases, comprising:
a purchase control system comprising:
a control circuit; and
a memory coupled to the control circuit and storing computer instructions that when executed by the control circuit cause the control circuit to:
receive a request to register a remote consumer device;
identify, from a plurality of different customers, a first registered customer with which the customer device is to be associated;
associate the customer device with a customer account corresponding to the first customer;
receive a purchasing authorization for the customer device as authorized by the first customer; and
define purchasing authorization limits of the customer device that set limits on the customer device's authorization to initiate purchases over time on behalf of the first customer for one or more products corresponding to the operation of the customer device.

2. The system of claim 1, wherein the control circuit is further configured to:
receive a product order from the previously registered customer device autonomously submitting a product order, wherein the product order specifies one or more products to be purchased on a behalf of the first customer with whom the customer device is associated;
identify the customer device, and authenticate the customer device submitting the product order;
confirm the customer device is registered to autonomously submit the product order on behalf of the first customer; and
authorize the product order in response to authenticating the customer device and confirming the customer device is registered.

3. The system of claim 2, wherein the control circuit is further configured to:
identify the first customer corresponding to the registered customer device based on the customer account established upon registration of the first customer;
identify a method of payment specified within the customer account; and
charge the method of payment for a cost of the one or more ordered products.

4. The system of claim 2, wherein the control circuit is further configured to:
evaluate the product order; and
confirm the one or more products being ordered comply with the one or more purchasing authorization limits specified and associated with the registered customer device;
wherein the control circuit, in authorizing the product order, authorizes the product order in response to authenticating the customer device, confirming the customer device is registered and confirming the one or more products being ordered comply with the one or more purchasing authorization limits.

5. The system of claim 2, wherein the control circuit is further configured to:
communicate an authorization request to a user interface unit corresponding to the first customer, wherein the authorization request requests that the first customer confirm authorization for the purchase of the one or more products;
wherein the control circuit, in authorizing the product order, authorizes the product order in response to authenticating the customer device, confirming the customer device is registered, and receiving an authorization from the first customer in response to the authorization request.

6. The system of claim 2, wherein the control circuit corresponds to a specific retailer and in receiving the product order is further configured to:
receive directly at the specific retailer the product order from the customer device that has previously been registered with the specific retailer and with which the first customer is also previously registered.

7. The system of claim 2, wherein the control circuit in receiving the product order is further configured to:
receive the product order in response to the customer device identifying that a quantity of at least one of the one or more products is equal to or less than a product threshold.

8. The system of claim 1, wherein the control circuit in defining the purchasing authorization limits is further configured to:
receive one or more product identifiers that the customer device is authorized to purchase, and receive one or more quantity limits corresponding to each of the received one or more product identifiers, wherein each of the quantity limits defines a maximum number of the corresponding product the customer device is authorized to purchase.

9. A method of providing customer device authorized purchases, comprising:
by a control circuit of a purchase control system:
receiving a request to register a remote consumer device;
identifying, from a plurality of different customers, a first registered customer with which the customer device is to be associated;
associating the customer device with a customer account corresponding to the first customer;
receiving a purchasing authorization for the customer device as authorized by the first customer; and
defining purchasing authorization limits of the customer device that set limits on the customer device's authorization to initiate purchases over time on behalf of the first customer for one or more products corresponding to the operation of the customer device.

10. The method of claim 9, further comprising:
receiving a product order from the previously registered customer device autonomously submitting a product order, wherein the product order specifies one or more products to be purchased on a behalf of the first customer with whom the customer device is associated;
identifying the customer device, and authenticating the customer device submitting the product order;
confirming the customer device is registered to autonomously submit the product order on behalf of the first customer; and
authorizing the product order in response to authenticating the customer device and confirming the customer device is registered.

11. The method of claim 10, further comprising:
identifying the first customer corresponding to the registered customer device based on a customer account established upon registration of the customer;
identifying a method of payment specified within the customer account; and
charging the method of payment for a cost of the ordered product.

12. The method of claim 10, further comprising
evaluating the product order; and
confirming the one or more products being ordered comply with the one or more purchasing authorization limits specified and associated with the registered customer device;
wherein the authorizing the product order comprises authorizing the product order in response to authenticating the customer device, confirming the customer device is registered and confirming the one or more products being ordered comply with the one or more purchasing authorization limits.

13. The method of claim 10, further comprising:
communicating an authorization request to a user interface unit corresponding to the first customer, wherein the authorization request requests that the first customer confirm authorization for the purchase of the one or more products;
wherein the authorizing the product order comprises authorizing the product order in response to authenticating the customer device, confirming the customer device is registered, and receiving an authorization from the first customer in response to the authorization request.

14. The method of claim 10, wherein the receiving the product order comprises receiving directly at a specific retailer the product order from the customer device that has previously been registered with the specific retailer and with which the first customer is also previously registered.

15. The method of claim 10, wherein the receiving the product order comprises receiving the product order in response to the customer device identifying that a quantity of at least one of the one or more products is equal to or less than a product threshold.

16. The method of claim 9, wherein the defining the purchasing authorization limits comprises receiving one or more product identifiers that the customer device is authorized to purchase, and receiving one or more quantity limits corresponding to each of the received one or more product identifiers, wherein each of the quantity limits defines a maximum number of the corresponding product the customer device is authorized to purchase.
